(19) United States
(12) Patent Application Publication
(10) Pub. No.: US 2024/0283097 A1
(43) Pub. Date: Aug. 22, 2024

(54) ALL-SOLID-STATE BATTERY

(71) Applicant: SAMSUNG ELECTRO-MECHANICS CO., LTD., Suwon-si, Gyeonggio-do (KR)

(72) Inventors: Kyongbok Min, Suwon-si, Gyeonggi-do (KR); Taehoon Kim, Suwon-si, Gyeonggi-do (KR); Seungjin Park, Suwon-si, Gyeonggi-do (KR); Minsoo Kim, Suwon-si, Gyeonggi-do (KR); Namgyu Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/024,712

(22) PCT Filed: Nov. 14, 2022
(86) PCT No.: PCT/KR2022/017831

§ 371 Date: Mar. 3, 2023

(30) Foreign Application Priority Data
Dec. 20, 2021 (KR) 10-2021-0182948

(51) Int. Cl. H01M 50/51; H01M 50/529

(52) U.S. Cl. CPC H01M 50/51; H01M 50/529

(57) ABSTRACT

An all-solid-state battery according to the present disclosure includes: a support that includes one surface; a plurality of unit battery cells that are arranged in a first direction that is parallel with the surface of the support, each including a first electrode portion and a second electrode portion with a solid electrolyte portion therebetween in a second direction that is perpendicular to the surface of the support; and an electrode connection portion that extends in the second direction, and connects first electrode portions and second electrode portions of different unit cells in series.

### TECHNICAL FIELD

The present disclosure relates to an all-solid-state battery.

### BACKGROUND ART

Recently, as the down-size and long-term use of portable electronic devices is required, high-capacity of batteries are required, and battery safety is required to ensure the distribution of wearable electronic devices. Therefore, the development of an all-solid-state battery that uses a solid electrolyte instead of a liquid electrolyte is actively progressing.

All-solid-state batteries do not use flammable organic solvents, and thus additional circuits for safety can be simplified. Therefore, it is expected as a technology capable of manufacturing high-capacity safe batteries per unit volume.

The above information disclosed in this Background section is only for enhancement of understanding of the background of the disclosure, and therefore it may contain information that does not form the prior art that is already known in this country to a person of ordinary skill in the art.

### DISCLOSURE OF INVENTION

### Technical Problem

One aspect of the embodiment is to provide a segment type of stacked all-solid-state battery divided into a plurality of cells to realize high voltage and high-capacity batteries.

However, the problems to be solved by the embodiments are not limited to the above-described problems, and may be variously expanded in the range of the technical ideas included in the embodiments.

### Solution to Problem

An all-solid-state battery according to an embodiment includes: a support that includes one surface: a plurality of unit battery cells arranged in a first direction that is parallel with the surface of the support on the surface of the support, each unit battery cell including a first electrode portion and a second electrode portion with a solid electrolyte portion therebetween in a second direction that is perpendicular to the surface of the support; and an electrode connection portion that extends in the second direction, and connects first electrode portions and second electrode portions of different unit cells in series.

In one of the plurality of unit battery cells, edges of the first electrode portion and the second electrode portion may be disposed to be displaced from each other by a predetermined distance in the first direction.

In the one of the plurality of unit battery cells and another of the plurality of unit battery cells connected to the one of the plurality of unit battery cells, the electrode connection portion between the one of the plurality of unit battery cells and the another of the plurality of unit battery cells may be in contact with a bottom surface of one end of the second electrode portion of the one of the plurality of unit battery cells and a top surface of one end of the first electrode portion of the another of the plurality of unit battery cells.

The electrode connection portion between the one of the plurality of unit battery cells and the another of the plurality of unit battery cells may extend to the support while covering a side surface of one end of the first electrode portion of the another of the plurality of unit battery cells.

The solid electrolyte portion may cover a top surface and a side surface of the first electrode portion of one of the plurality of unit battery cells.

Solid electrolyte portions included in the different unit battery cells may be divided by the electrode connection portion in the first direction.

The second electrode portions that neighbor each other in the first direction may be divided by a margin electrolyte portion.

Conductivity of the margin electrolyte portion may be lower than conductivity of the solid electrolyte portion.

A top end of the electrode connection portion may be in contact with the boundary between the second electrode portion and the margin electrolyte portion.

The all-solid-state battery may further include: a first current collecting portion that is connected to a first connection portion located at one outermost side of the plurality of unit battery cells; and a second current collecting portion that is connected to a second electrode portion located at the other outermost side of the plurality of unit battery cells.

The maximum thickness in the second direction of the first current collecting portion and the second current collecting portion may be the same as the sum of the maximum thicknesses in which the first electrode portion, the solid electrolyte portion, and the second electrode portion are stacked in the second direction.

The support may include an electrolyte support.

The all-solid-state battery may include a first all-solid-state battery layer and a second all-solid-state battery layer that are stacked in the second direction and connected in parallel with each other, and the first all-solid-state battery layer and the second all-solid-state battery layer may respectively include the support, a plurality of unit battery cells, and electrode connection portion.

An all-solid-state battery according to another embodiment includes: a support that includes first and second surfaces that face toward opposite directions; a plurality of upper unit battery cells arranged adjacent to each other in a first direction that is parallel with the first surface of the support on the first surface, each upper unit battery cell including a first electrode portion and a second electrode portion that are stacked with a first solid electrolyte portion therebetween in a second direction that is perpendicular to the first surface of the support; an upper electrode connection portion that extends in the second direction, and connects first electrode portions and second electrode portions of different upper unit battery cells in series; a plurality of lower unit battery cells that are arranged in the first direction on the second surface of the support, each lower unit battery cell including a third electrode portion and a fourth electrode portion that are stacked with a second solid electrolyte portion therebetween in the second direction; and a lower electrode connection portion that extends in the second direction, and connects third electrode portions and fourth electrode portions of different unit battery cells in series

In one of the plurality of upper unit battery cells, edges of the first electrode portion and the second electrode portion may be disposed to be displaced from each other by a first predetermined distance in the first direction, and in one of the plurality of lower unit battery cells, edges of the third electrode portion and the fourth electrode portion may be disposed to be displaced from each other by a second predetermined width in the first direction.

In one of the plurality of upper unit battery cells and another of the plurality of upper unit battery cells connected to the one of the plurality of upper unit battery cells, the upper electrode connection portion between the one of the upper plurality of unit battery cells and the another of the plurality of upper unit battery cells may be in contact with a bottom surface of one end of the second electrode portion of the one of the plurality of upper unit battery cells and a top surface of one end of the first electrode portion of the another of the plurality of upper unit battery cells, and in one of the plurality of lower unit battery cells and another of the plurality of lower unit battery cells connected to the one of the plurality of lower unit battery cells, the lower electrode connection portion may be in contact with a top surface of one end of the fourth electrode portion of the one of the plurality of lower unit battery cells and a bottom surface of one end of the third electrode portion of the another of the plurality of lower unit battery cells.

The upper electrode connection portion may extend to the support while covering a side surface of one end of the first electrode portion of one of the plurality of upper unit battery cells, and the lower electrode connection portion may extend to the support, while covering a side surface of one end of the third electrode portion of one of the plurality of upper unit battery cells.

The second electrode portions that neighbor each other in the first direction may be divided by an upper margin electrolyte portion, and the fourth electrode portions that neighbor each other in the first direction may be divided by a lower margin electrolyte portion.

A top end of the upper electrode connection portion may be disposed to be in contact with the boundary between the second electrode portion and the upper margin electrolyte portion, and a lower end of the lower electrode connection portion may be disposed to be in contact with the boundary between the fourth electrode portion and the lower margin electrolyte portion.

The all-solid-state battery may further include: a first current collecting portion and a second current collecting portion that are respectively located at opposing outermost sides of the plurality of upper unit battery cells and respectively connected to the first electrode portion and the second electrode portion; and a third current collecting portion and a fourth current collecting portion that are respectively located at opposing outermost sides of the plurality of lower unit battery cells and respectively connected to the third electrode portion and the fourth electrode portion, wherein the first current collecting portion may be connected with the third current collecting portion, and the second current collecting portion may be connected with the fourth current collecting portion.

### Advantageous Effects of Invention

The all-solid-state battery according to the embodiments can implement a battery of high voltage and high-capacity by dividing the battery cell into a plurality of cells to form a segment-type stacked cell.

In addition, according to the embodiments, a process cost of the all-solid-state battery that can reduce by minimizing the number of processes by reducing the number of stacks in the vertical direction when implementing the same capacity.

### BRIEF DESCRIPTION OF DRAWINGS

FIG. 1 is a schematic perspective view of an all-solid-state battery according to an embodiment.

FIG. 2 is a cross-sectional view of FIG. 1, taken along the line II-II′.

FIG. 3 is a cross-sectional view of the all-solid-state battery with a high-capacity and serial-parallel structure in which the all-solid-state battery according to the embodiment of FIG. 1 is stacked in plural.

FIG. 4 is a cross-sectional view of an all-solid-state battery with a high-capacity and in-parallel structure according to another embodiment.

### MODE FOR THE INVENTION

In the following detailed description, only certain embodiments of the present disclosure have been shown and described, simply by way of illustration. The drawings and description are to be regarded as illustrative in nature and not restrictive. Like reference numerals designate like elements throughout the specification. Further, some constituent elements in the accompanying drawings are exaggerated, omitted, or schematically illustrated, and a size of each constituent element does not fully reflect an actual size.

Further, the accompanying drawings are provided for helping to easily understand embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms. The terms are used only to discriminate one constituent element from another constituent element.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “on” in a direction opposite to gravity.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. In the specification, unless explicitly described to the contrary. the word “comprise” and variations such as “comprises” or “comprising” will be understood to imply the inclusion of stated elements but not the exclusion of any other elements.

Further, throughout the specification, when it is referred to as “planar”, it means the case where a target part is viewed from above, and when it is referred to as “in a cross-section”, it means the case where a cross-section obtained by vertically cutting the target part is viewed from the side.

Further, throughout the specification, when it is referred to as “connected”, this does not only mean that two or more constituent elements are directly connected, but may mean that two or more constituent elements are indirectly connected through another constituent element, are physically connected, electrically connected, or are integrated even though two or more constituent elements are referred as different names depending on a location and a function.

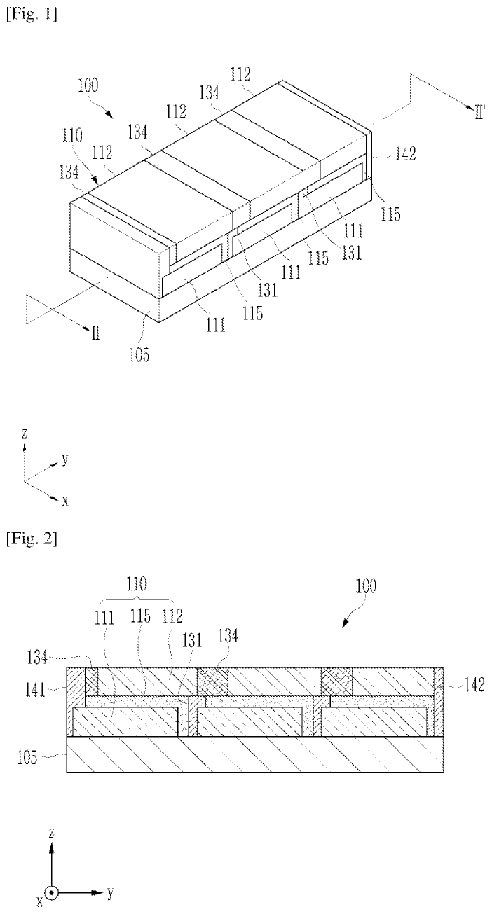

FIG. 1 is a schematic perspective view of an all-solid-state battery according to an embodiment, and FIG. 2 is a cross-sectional view of FIG. 1, taken along the line II-II′.

Referring to FIG. 1 and FIG. 2, an all-solid-state battery 100 according to the present embodiment includes a structure in which a plurality of unit battery cells 110 are connected in series through electrode connection portions 131 on a support 105. In FIG. 1, it is exemplarily illustrated that three unit battery cells 110 are connected to form the all-solid-state battery 100, although the number of battery cells of the all-solid-state battery 100 is not limited thereto.

The support 105 may be formed in the form of a sheet having one plane. The support 105 may be formed as an electrolyte support, for example, a ceramic electrolyte support or LSBO-based support. The LSBO may be Li₂O—SiO₂—B₂O₃, and may be formed of lithium boron silicate-based oxide electrolyte by mixing and heat treatment of each constituent material.

A plurality of unit battery cells 110 may be arranged adjacent to each other in a first direction (y-axis direction of drawing) parallel to the plane of the support 105 on a plane. Each unit battery cell 110 includes a first electrode portion 111 and a second electrode portion 112 stacked by disposing the solid electrolyte portion 115 therebetween. The first electrode portion 111, the solid electrolyte portion 115, and the second electrode portion 112 may be sequentially stacked from the surface of the support 105 in a second direction (z-axis direction of drawing) that is perpendicular to the plane of the support 105.

Edges of the first electrode portion 111 and the second electrode portion 112 may be disposed to be displaced from each other by a predetermined distance in the first direction. That is, along the first direction (y-axis direction of drawing) parallel to the plane of the support 105, the edge of the second electrode portion 112 may be offset from the edge of the first electrode portion 111, and thus, the edge of the second electrode portion 112 may not be aligned to the edge of the first electrode portion 111 in the second direction (z-axis direction of drawing) that is perpendicular to the plane of the support 105. For example, the second electrode portions 112 may be displaced to be displaced from the first electrode portion 111 by a distance by which the first electrode portions 111 are spaced apart from each other in the first direction. The first electrode portion 111 and the second electrode portion 112 may respectively include electrode current collectors on each of which an electrode active material layer is coated on both sides, and the first electrode portion 111 and the second electrode portion 112 may be formed to include electrodes of opposite polarity. For example, the first electrode portion 111 may form a positive electrode portion by coating a positive active material layer on both sides of the positive current collector, and the second electrode portion 112 may form a negative electrode portion by coating a negative active material layer on both sides of the negative electrode current collector.

The electrode connection portion 131 may extend in a second direction such that the first electrode portion 111 and the second electrode portion 112, each formed of different unit battery cells 110, and are connected in series. That is, a second electrode portion 112 of one unit battery cell 110 may be electrically connected to a first electrode portion 111 of another neighboring unit battery cell 110 through the electrode connection portion 131. Accordingly, the plurality of unit battery cells 110 may be connected in series on the support 105. The electrode connection portion 131 may be formed of, for example, a transition metal such as cobalt (Co), or formed of a ceramic conductor. Since cobalt (Co) has high electron conductivity among transition metals, it is possible to improve electron conductivity by adding cobalt to a ceramic structure material, and thus the electrode connection portion of the ceramic conductor can be used as an electron movement passage between the positive electrode and the negative electrode.

When the second electrode portion 112 is offset from the first electrode portion 111, the electrode connection portion 131 may be connected to an upper surface of one end of a first electrode portion 111 of one unit battery cell 110 that is adjacent to a bottom surface of one end of a second electrode portion 112 of a different unit battery cell 110. In addition, such an electrode connection portion 131 may extend to the support 105 while covering a side surface of one end of the first electrode portion 111.

The solid electrolyte portion 115 is disposed between the first electrode portion 111 and the second electrode portion 112, and may be formed to cover an upper surface and a side surface of the first electrode portion 111. Therefore, the solid electrolyte portions 115 included in different unit battery cells 110 may be divided by the electrode connection portion 131 in the first direction. In addition, the solid electrolyte portion 115 and the electrode connection portion 131 may be interposed between the first electrode portions 111 adjacent to each other. Accordingly, in the structure in which a plurality of first electrode portions 111 are patterned on the support 105, a process of filling a separate insulating material may not be required.

For example, an LATP electrolyte (Li₁₊ₓAlₓTi₂₋ₓ(PO₄)₃ (0≤x≤0.6)) may be used as the solid electrolyte portion 115. For another example, a NASICON-based electrolyte (Li₁₊ₓAlₓM₂₋ₓ(PO₄)₃) electrolyte or an amorphous (glass) electrolyte may be used as the solid electrolyte portion 115.

A margin electrolyte portion 134 may be interposed between a plurality of second electrode portions 112 adjacent in the first direction. That is, the plurality of second electrode portions 112 may be divided by the margin electrolyte portion 134 to insulate adjacent second electrode portions 112 from each other. In this case, the ion conductivity of the margin electrolyte portion 134 may be lower than the ion conductivity of the solid electrolyte portion 115, for example, may have ion conductivity of 1.0×10⁻¹⁰ S/cm or less.

In this case, a top end of the electrode connection portion 131 may be disposed so as to be in contact with the boundary between the second electrode portion 112 and the margin electrolyte portion 134. The electrode connection portion 131 may be formed such that a width measured in the first direction of the top end in contact with the second electrode portion 112 and the margin electrolyte portion 134 is larger than a width of the lower end in contact with the support 105.

A first current collecting portion 141 may be provided at one side of the all-solid-state battery 100 according to the present embodiment, and a second current collecting portion 142 may be provided at the other side thereof. In this case, the first current collecting portion 141 may be connected to a first electrode portion 111 positioned at one outermost side of the plurality of unit battery cells 110, and the second current collecting portion 142 may be connected to a second electrode portion 112 disposed at the other outermost side of the plurality of unit battery cells 110. Thus, when the first electrode portion 111 forms a positive electrode, the first current collecting portion 141 may become a positive electrode current collecting portion, and when the second electrode portion 112 forms a negative electrode, the second current collecting portion 142 may become a negative electrode current collecting portion.

The first current collecting portion 141 and the second current collecting portion 142 may be positioned on the support 105. The maximum thickness in the second direction of the first current collecting portion 141 and the second current collecting portion 142 may be the same as the sum of the maximum thicknesses in which the first electrode portion 111, the solid electrolyte portion 115, and the second electrode portion 112 are stacked in the second direction.

Although it is not illustrated in FIG. 1 and FIG. 2, an upper cover having an insulation property may be disposed over the second electrode portion 112 of the all-solid-state battery 100, and a lower cover having an insulation property may be added to a lower portion of the support 105. In the following embodiments as well, the upper cover and the lower cover may be added.

In addition, although it exemplarily illustrated in FIG. 1 and FIG. 2 that three unit battery cells are connected with each other in a planar direction, this is not restrictive. and four or more unit battery cells are arranged in a planar direction and connected in series, thereby forming an all-solid state battery, and this is also included in the scope of the present disclosure.

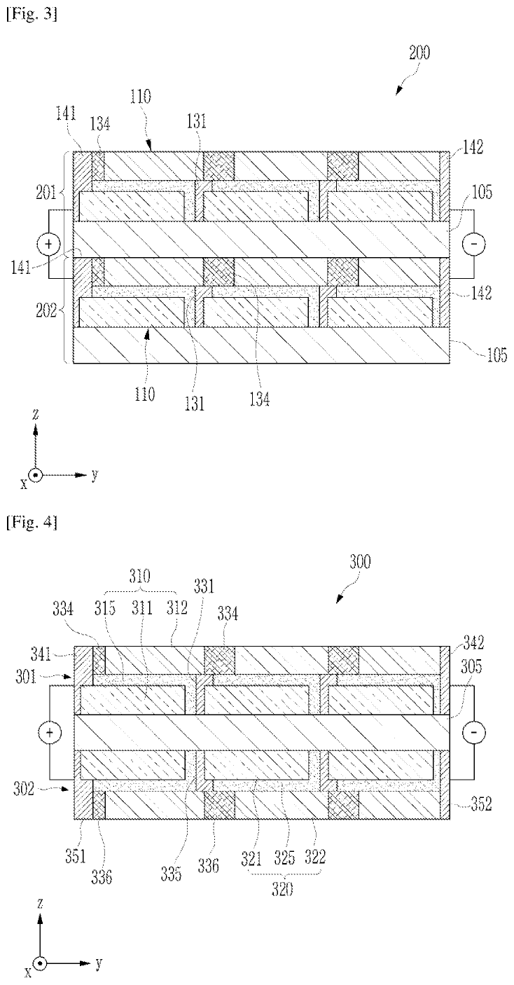

FIG. 3 is a cross-sectional view of an all-solid-state battery with a high-capacity serial-parallel structure in which the all-solid-state battery according to the embodiment of FIG. 1 is stacked in plural.

Referring to FIG. 3, an all-solid-state battery 200 according to the present embodiment includes a first all-solid-state battery layer 201 and a second all-solid-state battery layer 202. The first all-solid-state battery layer 201 and the second all-solid-state battery layer 202 may be stacked in a second direction (z-axis direction in the drawing) and thus may be connected in parallel with each other.

Each configuration of the first all-solid-state battery layer 201 and the second all-solid-state battery layer 202 may have the structure of the all-solid-state battery described above with reference to FIG. 1 and FIG. 2. That is, a plurality of unit battery cells 110 on a support 105 may be arranged in the first direction (the y-axis direction of drawing) while being connected in series by an electrode connection portion 131.

Each of the first all-solid state battery layer 201 and the second all-solid-state battery layer 202 may be provided with a first current collecting portion 141 at one side and a second current collecting portion 142 at the other side. In addition, the first all-solid-state battery layer 201 and the second all-solid-state battery layer 202 stacked in the second direction are electrically connected through the respective first current collecting portions 141 at one side and electrically connected through the respective second current collecting portions 142 at the other side such that they may be connected in parallel with each other.

Thus, a plurality of unit battery cells 110 in each of the first all-solid-state battery layer 201 and the second all-solid-state battery layer 202 may be connected in series. and the first all-solid-state battery layer 201 and the second all-solid-state battery layer 202 may be connected in parallel. Accordingly, it possible to implement a high voltage and high-capacity all-solid-state battery by configuring the battery to include both parallel and series connection.

FIG. 4 is a cross-sectional view of an all-solid-state battery with a high-capacity serial-parallel structure according to another embodiment.

Referring to FIG. 4, an all-solid-state battery 300 according to the present embodiment includes a first unit battery layer 301 and a second unit battery layer 302 that are connected in series respectively through a plurality of unit battery cells 310 and 320 and electrode connection portions 331 and 335 at both sides of a support 305. That is, the first unit battery layer 301 may be formed by a plurality of upper unit battery cells 310 connected through an upper electrode connection portion 331 on one plane of the support 305, and the second unit battery layer 302 may be formed by a plurality of lower unit battery cells 320 connected through a lower electrode connection portion 335 on another plane of the support 305. Accordingly, the first unit battery layer 301 and the second unit battery layer 302 may have a structure that is vertically symmetrical based on the support 305. In FIG. 4, although it is exemplarily illustrated that the all-solid-state battery 300 is formed by connecting three unit battery cells 310 and 320 in the upper and lower portions, four or more unit battery cells may be respectively included, respectively, and this also falls within the scope of the present disclosure.

The support 305 may be formed of a sheet with two planes facing each other in opposite directions. The support 305 may be formed as an electrolyte support, for example, a ceramic electrolyte support or an LSBO-based support. Here, the LSBO may be Li₂O—SiO₂—B₂O₃, and may be formed of a lithium boron silicate-based oxide electrolyte by mixing and heat treatment of each constituent material.

A plurality of upper unit battery cells 310 may be arranged adjacent to each other in a first direction (y-axis direction of drawing) parallel to the plane of the support 305 on a plane. Each upper unit battery cell 110 includes a first electrode portion 311 and a second electrode portion 312 stacked by disposing the solid electrolyte portion 315 therebetween. The first electrode portion 311, the solid electrolyte portion 315, and the second electrode portion 312 may be sequentially stacked from the surface of the support 305 in a second direction (z-axis direction of the drawing) that is perpendicular to the plane of the support 305.

Edges of the first electrode portion 311 and the second electrode portion 312 may be disposed to be displaced from each other by a predetermined distance in the first direction. That is, along the first direction (y-axis direction of drawing) parallel to the plane of the support 305, the edge of the second electrode portion 312 may be offset from the edge of the first electrode portion 311, and thus, the edge of the second electrode portion 312 may not be aligned to the edge of the first electrode portion 311 in the second direction (z-axis direction of drawing) that is perpendicular to the plane of the support 305. For example, the second electrode portions 312 may be displaced to be displaced from the first electrode portion 311 by a distance by which the first electrode portions 311 are spaced apart from each other in the first direction.

The upper electrode connection portion 331 may extend in a second direction such that the first electrode portion 111 and the second electrode portion 112, each formed of different upper unit battery cells 310, are connected in series. That is, a second electrode portion 312 of one upper unit battery cell 310 may be electrically connected to a first electrode portion 311 of another neighboring upper unit battery cell 310 through the upper electrode connection portion 331. Accordingly, the plurality of upper unit battery cells 110 may be connected in series on the support 305.

When the second electrode portion 312 is offset from the first electrode portion 311. the upper electrode connection portion 331 may be connected to an upper surface of one end of a first electrode portion 311 of one upper unit battery cell 310 that is adjacent to a bottom surface of one end of a second electrode portion 312 of a different upper unit battery cell 310. In addition, such an upper electrode connection portion 331 may extend to the support 305 while covering a side surface of one end of the first electrode portion 311.

The solid electrolyte portion 315 is disposed between the first electrode portion 311 and the second electrode portion 312, and may be formed to cover an upper surface and a side surface of the first electrode portion 311. Therefore, the solid electrolyte portions 315 included in different upper unit battery cells 310 may be divided by the upper electrode connection portion 331 in the first direction. In addition, the solid electrolyte portion 315 and the upper electrode connection portion 331 may be interposed between the first electrode portions 311 adjacent to each other.

For example, an LATP electrolyte (Li₁₊ₓAlₓTi₂₋ₓ(PO₄)₃ (0≤x≤0.6)) may be used as the solid electrolyte portion 315. For another example, a NASICON-based electrolyte (Li₁₊ₓAlₓM₂₋ₓ(PO₄)₃) electrolyte or an amorphous (glass) electrolyte may be used as the solid electrolyte portion 315.

An upper margin electrolyte portion 334 may be interposed between a plurality of second electrode portions 312 adjacent in the first direction. That is, the plurality of second electrode portions 312 may be divided by the upper margin electrolyte portion 334 to insulate adjacent second electrode portions 312 from each other.

In this case, a top end of the upper electrode connection portion 331 may be disposed so as to be in contact with the boundary between the second electrode portion 312 and the upper margin electrolyte portion 334. The upper electrode connection portion 331 may be formed such that a width measured in the first direction of the top end in contact with the second electrode portion 312 and the upper margin electrolyte portion 334 is larger than a width of the lower end in contact with the support 305.

Meanwhile, a plurality of lower unit battery cells 320 may be arranged adjacent to each other in the first direction on another plane of the support 305. Each lower unit battery cell 320 includes a third electrode portion 321 and a fourth electrode portion 322 stacked with a solid electrolyte portion 325 interposed therebetween. The third electrode portion 321, the solid electrolyte portion 325, and the fourth electrode portion 322 may be sequentially stacked from the surface of the support 305 in the second direction.

Edges of the third electrode portion 321 and the fourth electrode portion 322 in the first direction may be disposed to be displaced from each other by a predetermined distance. That is, along the first direction (y-axis direction of drawing) parallel to the plane of the support 305, the edge of the fourth electrode portion 322 may be offset from the edge of the third electrode portion 321, and thus, the edge of the fourth electrode portion 322 may not be aligned to the edge of the third electrode portion 321 in the second direction (z-axis direction of drawing) that is perpendicular to the plane of the support 305. For example, the fourth electrode portion 322 may be displaced to be displaced from the first electrode portion 311 by a distance by which the third electrode portions 321 are spaced apart from each other in the first direction.

The lower electrode connection portion 335 may extend in the second direction to connect a third electrode portion 321 and a fourth electrode portion 322 of the different lower unit battery cells 320 in series. That is, a fourth electrode portion 322 of one lower unit battery cell 320 may be electrically connected to a third electrode portion 321 of another adjacent lower unit battery cell 320 through the lower electrode connection portion 335. Accordingly, a plurality of lower unit battery cells 320 may be connected in series on the support 305.

When the fourth electrode portion 322 is offset from the third electrode portion 321, the lower electrode connection portion 335 may be connected to a bottom surface of one end of a third electrode portion 321 of one lower unit battery cell 320 that is adjacent to a top surface of one end of a fourth electrode portion 322 of a different lower unit battery cell 320. In addition, such a lower electrode connection portion 335 may extend to the support 305 while covering a side surface of one end of the third electrode portion 321.

The solid electrolyte portion 325 is disposed between the third electrode portion 321. and the fourth electrode portion 322, and may be formed to cover a bottom surface and a side surface of the third electrode portion 321. Therefore, the solid electrolyte portions 325 included in different lower unit battery cells 330 may be divided by the lower electrode connection portion 335 in the first direction. In addition, the solid electrolyte portion 325 and the lower electrode connection portion 335 may be disposed between the third electrode portions 321 adjacent to each other.

A lower margin electrolyte portion 336 may be disposed between a plurality of fourth electrode portions 322 adjacent to each other in the first direction. That is, the plurality of fourth electrode portions 322 may be divided by the lower margin electrolyte portion 336 to insulate adjacent fourth electrode portions 322 from each other.

In this case, a lower end of the lower electrode connection portion 335 may be disposed so as to be in contact with the boundary between the fourth electrode portion 322 and the lower margin electrolyte portion 336. The lower electrode connection portion 335 may be formed such that a width measured in the first direction of the lower end in contact with the fourth electrode portion 322 and the lower margin electrolyte portion 336 is larger than a width of the top end in contact with the support 305.

Meanwhile, a first current collecting portion 341 and a third current collecting portion 351 are provided at one side of the all-solid-state battery 300 according to the present embodiment, and a second current collecting portion 342 and a fourth current collecting portion 352 may be provided at the other side. In this case, the first current collecting portion 341 may be connected to a first electrode portion 311 positioned at one outermost side of the plurality of upper unit battery cells 310, and the second current collecting portion 342 may be connected to a second electrode portion 312 disposed at the other outermost side of the plurality of upper unit battery cells 310. In addition, the third current collecting portion 351 may be connected to a third electrode portion 321 positioned at one outermost side of the plurality of lower unit battery cells 320, and the fourth current collecting portion 352 may be connected to a fourth electrode portion 322 disposed at the other outermost side of the plurality of lower unit battery cells 320. Thus, when the first electrode portion 311 and the third electrode portion 321 form a positive electrode, the first current collecting portion 341 and the third current collecting portion 351 may become a positive electrode current collecting portion, and when the second electrode portion 312 and the fourth electrode portion 322 form a negative electrode, the second current collecting portion 342 and the fourth current collecting portion 352 may become a negative electrode current collecting portion.

The all-solid-state battery according to the embodiments described with reference to the above drawings is a stacked all-solid-state battery structure of a segment type. which is separated into several cells in the shape of a node. As a result, it is possible to form a module in which thin-layered unit cells are freely connected in series/in parallel, and thus a high-efficiency all-solid-state battery system can be realized with high voltage and high-capacity.

According to the embodiments, it is possible to reduce the number of stacks in the vertical direction based on the purpose of implementing the same capacity, thereby reducing the number of processes and reducing process costs. In addition, it is possible to reduce the module volume in the final all-solid-state battery system, enabling high efficiency development.

According to the embodiments, since it is a structure that does not need to be filled with an insulating film material between the battery constituent elements patterned on a monolithic support, process costs and time can be reduced. Furthermore, it is possible to realize a mechanically stable and robust structure, and it is a structure in which performance improvement can be expected by mechanically reducing the internal resistance of the battery.

According to the embodiments, it is possible to secure structural stability by uniform stress distribution on multiple surfaces during simultaneous firing, and performance stability and reliability improvement effect can be expected because it is possible to minimize the internal stress of the stacked cell structure due to the contraction/expansion phenomenon caused by Li⁺ movement in the electrode layer during charging and discharging.

According to the embodiments, mass production is easy because all constituent elements constituting the all-solid battery cell can be applied by a low-cost wet coating method (printing, spray process, etc.).

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

1. An all-solid-state battery comprising:
a support that includes one surface;
a plurality of unit battery cells that are arranged in a first direction that is parallel with the surface of the support on the surface of the support, each unit battery cell including a first electrode portion and a second electrode portion stacked with a solid electrolyte portion therebetween in a second direction that is perpendicular to the surface of the support; and
an electrode connection portion that extends in the second direction, and connects first electrode portions and second electrode portions of different unit cells in series.

2. The all-solid-state battery of claim 1, wherein
in one of the plurality of unit battery cells, edges of the first electrode portion and the second electrode portion are disposed to be displaced from each other by a predetermined distance in the first direction. The all-solid-state battery of claim 2, wherein

3. The all-solid-state battery of claim 2, wherein
in the one of the plurality of unit battery cells and another of the plurality of unit battery cells connected to the one of the plurality of unit battery cells, the electrode connection portion between the one of the plurality of unit battery cells and the another of the plurality of unit battery cells is in contact with a bottom surface of one end of the second electrode portion of the one of the plurality of unit battery cells and a top surface of one end of the first electrode portion of the another of the plurality of unit battery cells.

4. The all-solid-state battery of claim 3, wherein
the electrode connection portion between the one of the plurality of unit battery cells and the another of the plurality of unit battery cells extends to the support while covering a side surface of one end of the first electrode portion of the another of the plurality of unit battery cells.

5. The all-solid-state battery of claim 1, wherein
the solid electrolyte portion covers a top surface and a side surface of the first electrode portion of one of the plurality of unit battery cells.

6. The all-solid-state battery of claim 1, wherein
solid electrolyte portions included in the different unit battery cells are divided by the electrode connection portion in the first direction.

7. The all-solid-state battery of claim 1, wherein
the second electrode portions that neighbor each other in the first direction are divided by a margin electrolyte portion.

8. The all-solid-state battery of claim 7, wherein
conductivity of the margin electrolyte portion is lower than conductivity of the solid electrolyte portions.

9. The all-solid-state battery of claim 7, wherein a top end of the electrode connection portion is in contact with a boundary between the second electrode portion and the margin electrolyte portion.

10. The all-solid-state battery of claim 1, further comprising:
a first current collecting portion that is connected to a first connection portion located at one outermost side of the plurality of unit battery cells; and
a second current collecting portion that is connected to a second electrode portion located at the other outermost side of the plurality of unit battery cells.

11. The all-solid-state battery of claim 10, wherein
the maximum thickness in the second direction of the first current collecting portion and the second current collecting portion is the same as the sum of the maximum thicknesses in which the first electrode portion, the solid electrolyte portion, and the second electrode portion are stacked in the second direction.

12. The all-solid-state battery of claim 1, wherein
the support comprises an electrolyte support.

13. The all-solid-state battery of claim 1, wherein
the all-solid-state battery comprises a first all-solid-state battery layer and a second all-solid-state battery layer that are stacked in the second direction and connected in parallel with each other, and the first all-solid-state battery layer and the second all-solid-state battery layer respectively include the support, the plurality of unit battery cells, and the electrode connection portion.

14. An all-solid-state battery comprising:
a support that includes first and second surfaces that face toward opposite directions;
a plurality of upper unit battery cells arranged in a first direction that is parallel with the first surface of the support on the first surface, each upper unit battery cell including a first electrode portion and a second electrode portion that are stacked with a first solid electrolyte portion therebetween in a second direction that is perpendicular to the first surface of the support;
an upper electrode connection portion that extends in the second direction, and connects first electrode portions and second electrode portions of different upper unit battery cells in series;
a plurality of lower unit battery cells that are arranged in the first direction on the second surface of the support, each lower unit battery cell including a third electrode portion and a fourth electrode portion that are stacked with a second solid electrolyte portion therebetween in the second direction; and
a lower electrode connection portion that extends in the second direction, and connects third electrode portions and fourth electrode portions of different unit battery cells in series.

15. The all-solid-state battery of claim 14, wherein
in one of the plurality of upper unit battery cells, edges of the first electrode portion and the second electrode portion are disposed to be displaced from each other by a first predetermined distance in the first direction, and
in one of the plurality of lower unit battery cells, edges of the third electrode portion and the fourth electrode portion are disposed to be displaced from each other by a second predetermined width in the first direction.

16. The all-solid-state battery of claim 15, wherein
in one of the plurality of upper unit battery cells and another of the plurality of upper unit battery cells connected to the one of the plurality of upper unit battery cells, the upper electrode connection portion between the one of the upper plurality of unit battery cells and the another of the plurality of upper unit battery cells is in contact with a bottom surface of one end of the second electrode portion of the one of the plurality of upper unit battery cells and a top surface of one end of the first electrode portion of the another of the plurality of upper unit battery cells, and
in one of the plurality of lower unit battery cells and another of the plurality of lower unit battery cells connected to the one of the plurality of lower unit battery cells, the lower electrode connection portion is in contact with a top surface of one end of the fourth electrode portion of the one of the plurality of lower unit battery cells and a bottom surface of one end of the third electrode portion of the another of the plurality of lower unit battery cells.

17. The all-solid-state battery of claim 14, wherein
the upper electrode connection portion extends to the support while covering a side surface of one end of the first electrode portion of one of the plurality of upper unit battery cells, and
the lower electrode connection portion extends to the support, while covering a side surface of one end of the third electrode portion of one of the plurality of upper unit battery cells.

18. The all-solid-state battery of claim 14, wherein
the second electrode portions that neighbor each other in the first direction are divided by an upper margin electrolyte portion, and the fourth electrode portions that neighbor each other in the first direction are divided by a lower margin electrolyte portion.

19. The all-solid-state battery of claim 18, wherein
a top end of the upper electrode connection portion is disposed to be in contact with the boundary between the second electrode portion and the upper margin electrolyte portion, and
a lower end of the lower electrode connection portion is disposed to be in contact with the boundary between the fourth electrode portion and the lower margin electrolyte portion.

20. The all-solid-state battery of claim 14, further comprising:
a first current collecting portion and a second current collecting portion that are respectively located at opposing outermost sides of the plurality of upper unit battery cells and respectively connected to the first electrode portion and the second electrode portion; and
a third current collecting portion and a fourth current collecting portion that are respectively located at opposing outermost sides of the plurality of lower unit battery cells and respectively connected to the third electrode portion and the fourth electrode portion,
wherein the first current collecting portion is connected with the third current collecting portion, and
the second current collecting portion is connected with the fourth current collecting portion.
